(19) United States
(12) Patent Application Publication
(10) Pub. No.: US 2017/0110035 A1
(43) Pub. Date: Apr. 20, 2017

(54) SNAP-ON IDENTIFIER FOR A CABLE SUCH AS A MOBILE PHONE CHARGER CABLE

(71) Applicants: Allison M. Weglarz, Wake Forest, NC (US); Mark E. Weglarz, Wake Forest, NC (US)

(72) Inventors: Allison M. Weglarz, Wake Forest, NC (US); Mark E. Weglarz, Wake Forest, NC (US)

(21) Appl. No.: 15/291,128

(22) Filed: Oct. 12, 2016

Related U.S. Application Data
(60) Provisional application No. 62/242,345, filed on Oct. 16, 2015.

(51) Int. Cl. G09F 3/20; G09F 3/00

(52) U.S. Cl. CPC G09F 3/205; G09F 3/0295

(57) ABSTRACT

Disclosed herein is an identifier for a mobile phone charger cord or other electrical cord. The identifier comprises a snap-on device that is designed to be easily snapped on and snapped off of a cord. In one embodiment, the identifier includes a face, a back and a flexible connecting hinge, as well as a fastening structure for securing the face and back in a closed position around the cord.

### CROSS-REFERENCE TO RELATED APPLICATION

This application claims priority under 35 U.S.C. §119(e) from the following U.S. provisional application: Application Ser. No. 62/242,345 filed on Oct. 16, 2015. That application is incorporated in its entirety by reference herein.

### FIELD OF THE INVENTION

The present invention relates to electrical cables and more particularly to an identifier for a mobile phone charger cable and other cables.

### BACKGROUND OF THE INVENTION

The popularity of mobile phones throughout the world is undeniable. Consumers continue to purchase mobile phones and various accessories that compliment or facilitate the use of mobile phones. One indispensable accessory for the mobile phone is a charger cord or cable that enables the battery of the mobile phone to be charged by connecting the phone to an electrical outlet. Because of the extensive use of mobile phones, many people carry charger cords with them virtually all the time. At business meetings, coffee shops and family gatherings, it is not uncommon to see many charger cords lying around unattended. Eventually people turn to retrieving their charger cord and sometimes confusion sets in. This is because many charger cords are identical and unless specifically marked, it is difficult for one person to determine which one of the many charge cords belongs to him or her.

Therefore, there has been and continues to be a need for a unique identifier that is simple in design and is easy to attach and detach from a mobile phone charger cord.

### SUMMARY OF THE INVENTION

The present invention relates to a snap-on identifier that can be easily attached to a cord such as a mobile phone charger cord and easily detached from the charger cord.

In one embodiment, the snap-on cord identifier comprises a face and a back that are coupled together by a flexible hinge. The flexible hinge enables the identifier to assume an open position which allows the cord to be inserted into the identifier. Thereafter, the face and back is closed around the cord and secured in a closed position by one or more fasteners. When closed, a passageway is defined through the identifier and the cord extends through this passageway. A unique identifier is applied to a portion of the cord identifier that serves to distinguish one person's cord from another.

Other objects and advantages of the present invention will become apparent and obvious from a study of the following description and the accompanying drawings which are merely illustrative of such invention.

### BRIEF DESCRIPTION OF THE DRAWINGS

FIG. 1 is a perspective view showing the identifier of the present invention secured to a mobile phone charger cord.

FIG. 2 is a perspective view showing the identifier in a closed position.

FIG. 3 is a perspective view of the identifier shown in an open position.

FIG. 4 is an end elevational view of a mobile phone charger cord extending through the identifier which is disposed in a closed position.

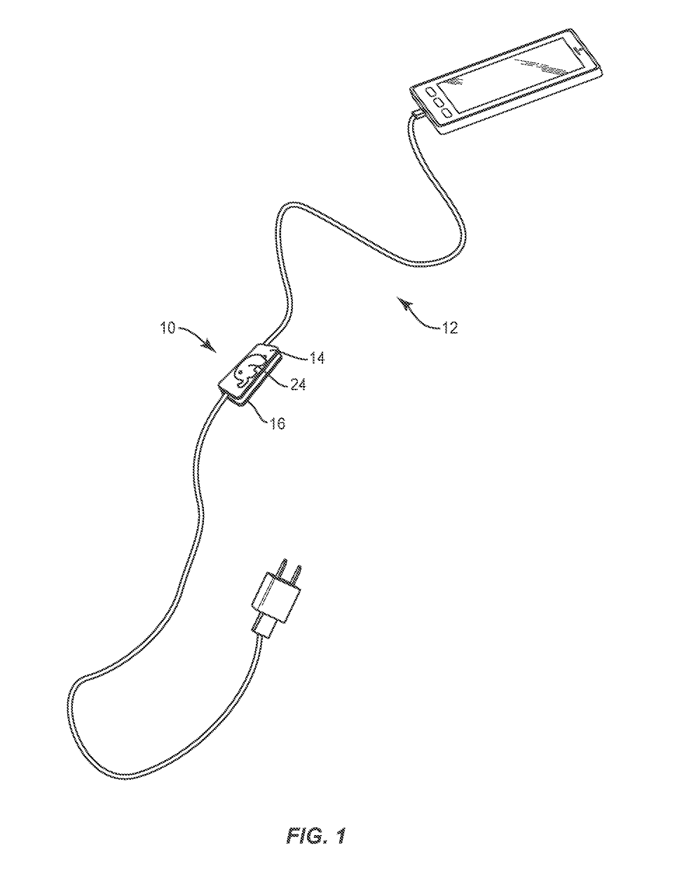

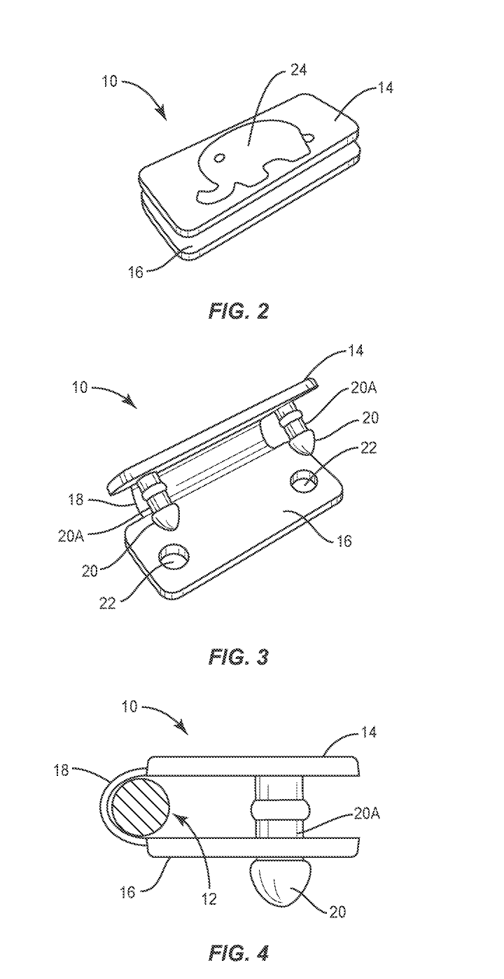

### DESCRIPTION OF THE EXEMPLARY EMBODIMENTS

With further reference to the drawings, a cord or cable identifier is shown therein and indicated generally by the numeral 10. The terms “cord” and “cable” are used interchangeably herein. As discussed herein, the cord identifier 10 is particularly suited for use with a mobile phone charger cord but it will be appreciated by those skilled in the art that the identifier can be used on a variety of cords or cables. Identifier 10 is designed to snap on and snap off of a cord. Shown in the drawings is a mobile phone charger cord that is indicated generally by the numeral 12. The identifier 10 is configured and designed to assume both an open position and a closed position. In the open position shown in FIG. 3, the cord 12 can be laid into the identifier and the identifier can be closed around the cord. Thus, the identifier is secured to the cord.

Turning to the drawings, the identifier 10 comprises a face 14 and a back 16. Face 14 and back 16 are interconnected by a flexible hinge 18. This flexible hinge 18 enables the face 14 and back 16 to swing back and forth towards each other and between open and closed positions. In the closed position, the outer surfaces of the face 14 and back 16 are exposed. See FIG. 4. In the embodiments illustrated herein, the face 14 and back 16 when in the closed position extend in generally parallel planes. It should be pointed out, however, that the face 14 and back 16 could be disposed such that they do not extend in parallel planes when the identifier 10 assumes the closed position. Those skilled in the art will appreciate that the face 14 and back 16 can assume various shapes such as square, rectangular, oval, oblong, etc.

Identifier 10 is provided with a fastening structure that enables the face 14 and back 16 to be held in the closed position. Various fastening structures can be employed. In one embodiment, the fastening structure includes a pair of studs 20. The studs 20 project from the inner surface of the face 14 and are spaced outwardly from the flexible hinge 18. Formed in the back 16 are a pair of openings 22 that are specifically spaced for receiving the studs 20. It should be appreciated that the openings 22 and studs 20 could be reversed. That is, the openings 22 could be provided in the face 14 and the studs 20 could project from the back 16. In any event, the studs 20 generally project from the face 14 such that the studs extend generally perpendicular to the plane of the face. In the embodiment illustrated herein, the studs 20 include an angular recess 20A disposed intermediately thereon. In the closed position, the openings 22 are generally disposed around the annular recess 20A. This, in some embodiments, has the effect of maintaining a spacing between the face 14 and back 16. In addition, the openings 22 are sized with respect to studs 20. Studs 20 cannot freely move into and through the opening 22. Thus, the openings 22 and the studs 20 are particularly sized with respect to each other such that the studs must be pushed or forced into the openings. Once in the openings 22, the studs tend to be retained therein by the openings extending around the recessed areas 20A. This assures that the identifier 10 is held in the closed position about the cord 12. This means that the openings 22 are at least slightly compliant. That is, when the head of the studs 20 engage the openings 22, the openings can slightly expand in response to the pressure exerted by the studs, allowing the studs to pass through the openings where the studs function to hold the face 14 and back 16 in the closed position shown in FIG. 4.

In the closed position, a cord passageway is defined through the identifier 10. Precisely where the cord passageway lies can vary. In one embodiment, the cord passageway lies immediately adjacent the flexible hinge 18. That is, when the identifier 10 is snapped onto the charger cord 12, the cord extends through the identifier 10 but closely adjacent the flexible hinge 18 as shown in FIG. 4. It is appreciated that, in some embodiments, the flexible hinge 18 may be more pronounced and may be sized to accommodate cords of larger or smaller cross-sectional areas.

In the embodiment illustrated herein, the identifier 10 is configured such that the charger cord 12 is not tightly held by the identifier. That is, in this embodiment, the charger cord 12 can be moved fore and aftly through the identifier 10 when the identifier assumes the closed position. However, in other embodiments, the identifier 10 can be sized and configured to tightly grip the cord when in the closed position.

Identifier 10 is provided with a unique identifier 24 that enables a person to identify his or her charger cord when the identifier is attached to a charger cord. Various types and forms of unique identifiers can be employed. The identifiers can be placed at various locations on the identifier 10. For example, the identifier 10 may include a person's initials, sports logos, designs, icons, and, as noted above, a wide variety of other indicia or markings that are capable of permitting a person to distinguish his or her charger cord from chargers cords of others.

Identifier 10 discussed herein can be constructed of various suitable materials. In one embodiment, it is contemplated that the identifier 10 is constructed of molded plastic. This will enable the identifier to be produced in a cost effective manner. As alluded to before, the identifier 10 is discussed throughout the present application in the context of a mobile phone charger cord. It is appreciated, however, that the identifier 10 can be applied to other types of charger cords and can also be applied to cords other than charger cords.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A snap-on universal cable identifier for identifying cables, the snap-on universal cable identifier comprising:
a face having an outer surface and an inner surface;
a back having an outer surface and an inner surface;
a flexible hinge connected to the face and back and extending between the face and back for enabling the face and back to move between an open position and a closed position;
one or more fastening studs projecting from the inner surface of one of the face or back;
one or more openings for receiving the one or more fastening studs formed on the other one of the face or back;
wherein in the open position the cable can be laid into the identifier;
wherein in the closed position the one or more studs project into and through the one or more openings and close the face and back about the cable;
wherein in the closed position the flexible hinge forms at least a portion of a cable passageway through the identifier and wherein the flexible hinge extends along the side of the cable extending through the identifier; and
a unique identifier provided on a portion of the identifier for identifying the cable extending through the snap-on identifier.

2. The snap-on universal cable identifier of claim 1 wherein the identifier is constructed of a plastic material and wherein the flexible hinge is connected to a side edge of the face and to a side edge of the back; and wherein the flexible hinge is pliable and in said closed position the flexible hinge assumes a generally arcuate shape.

3. The snap-on cable identifier of claim 1 wherein the one or more studs includes an angular recess formed on an intermediate portion thereof and wherein in the closed position the angular recess is disposed in the one or more openings so as to securely maintain the identifier in the closed position.

4. A method of securing a snap-on cable identifier to a cable wherein the identifier comprises a face, a back and a flexible hinge secured to the face and back, the method comprising: opening the identifier by flexing the flexible hinge such that the face and back are spaced apart and disposed in an open position but held together as a unit by the flexible hinge; laying the cable into the identifier while the identifier is in the open position by inserting the cable between the face and back; closing the identifier by moving the face and back towards each other and in the process causing the face and back and flexible hinge to generally surround the cable; and positioning the identifier in a closed position around the cable by causing a fastening structure associated with the identifier to connect the face and back together in a generally locked position.

5. The method of claim 4 wherein the flexible hinge forms, in part at least, a cable passageway through the identifier and wherein the method includes laying the cable in the identifier such that the cable extends immediately adjacent the flexible hinge.

6. The method of claim 5 wherein in the closed position the flexible hinge assumes a generally arcuate shape and wherein the flexible hinge extends around a portion of the cable extending through the identifier.

7. The method of claim 4 including snapping the face and back together in a locked position by projecting a stud from one of the face or back into one or more openings in the other one of the face and back such that in the closed position the one or more studs project into the one or more openings and secure the identifier in the closed position.

8. A cable identifier configured to be secured to a cable for identifying the cable, the cable identifier comprising: a face having an inner surface and an outer surface; a back having an inner surface and an outer surface; a hinge operatively connected to the face and back for permitting the face and back to move back and forth relative to each other and to move between an open position and a closed position; in the closed position, the face, back and hinge are configured to form a cable receiving passageway through the identifier and interiorly of the face, back and hinge; one or more fasteners for connecting the face and back together and for securing the back, face and hinge around the cable; and a unique identifier provided on a portion of the identifier for identifying the cable extending through the identifier.

9. The cable identifier of claim 8 wherein the hinge is a flexible hinge and assumes a generally arcuate configuration in the closed position and wherein the flexible hinge forms a part of the cable passageway through the identifier in the closed position such that the cable when secured within the identifier lies immediately adjacent the flexible hinge.

10. The cable identifier of claim 8 wherein the one or more fasteners extend between the face and back and are spaced outwardly from the hinge such that in the closed position the cable is surrounded by the face, back, hinge and the one or more fasteners.

11. The cable identifier of claim 10 wherein the one or more fasteners comprise one or more studs that project from one of the face or back into one or more openings formed in the other one of the face or back to secure the face and back in the closed position.

12. The cable identifier of claim 8 wherein both the face and back comprise a generally rectangular or square plate constructed of plastic material and wherein the hinge is a flexible hinge that comprises a pliable strip of plastic material interconnected between the face and back and wherein the one or more fasteners in the closed position are spaced outwardly from the flexible hinge such that the cable passageway defined in the identifier extends between the face, back, flexible hinge and the one or more fasteners.
